(19) United States
(12) Patent Application Publication
(10) Pub. No.: US 2007/0262663 A1
(43) Pub. Date: Nov. 15, 2007

(54) Driving device, motor vehicle vent and method for obtaining an equipotential line in the driving device

(76) Inventor: Laurent Cheramy, Vielles Maisons Sur Joudry (FR)

Correspondence Address: CARLSON, GASKEY & OLDS, P.C., 400 WEST MAPLE ROAD, SUITE 350, BIRMINGHAM, MI, 48009, US

(21) Appl. No.: 11/706,414

(22) Filed: Feb. 13, 2007

(30) Foreign Application Priority Data
Feb. 15, 2006 (FR) 06 01 318

(51) Int. Cl. H02K 11/00; B60H 1/00

(52) U.S. Cl. 310/68 R; 454/69

(57) ABSTRACT

A driving device includes an electric motor having a yoke and a shaft. The driving device also includes a control board connected to ground and a conductive seal connecting the control board and the electric motor. The yoke is connected to ground via the conductive seal.

### REFERENCE TO RELATED APPLICATIONS

This application claims priority to French Patent Application FR 06 01 318 filed on Feb. 15, 2006.

### FIELD OF THE INVENTION

This invention relates generally to a driving device, a motor vehicle vent including the driving device, and a method for obtaining an equipotential line in the driving device.

### BACKGROUND OF THE INVENTION

Vehicles can be fitted with equipment, such as window regulators or sun roofs. The equipment can be electrically actuated by a driving device, in particular by a geared motor. The geared motor can include an electric motor that drives a reducing gear, which is connected to a vent to drive the vent. Motor windings are powered by a commutator that receives supply current via brushes. The brushes are fixed relative to the geared motor and have electrical contact by friction with the commutator driven in rotation by the geared motor. Moreover, the geared motor can be provided with a control board that controls operation of the geared motor. The control board is connected to a power supply via a connector. The power supply generally includes a pole at 12 V+0/2.5 V and a pole connected to ground.

It is desirable to connect a motor yoke, including a stator, to ground. This is generally realized by connecting the motor yoke to the control board of the geared motor, the control board itself being connected to ground via the connector. The connection can, for example, be realized by a conducting pin mounted on the control board. The conducting pin can break or not connect correctly to the motor yoke or to the control board, and this can lead to a bad contact. Moreover, in the event of vibrations, a noise may be produced as a result of metal contact between the conducting pin and the motor yoke or the control board. Alternatively, the connection can be realized by a conductive braid, but this solution is expensive.

### SUMMARY OF THE INVENTION

The present invention provides a driving device connected to ground of a yoke that is reliable and inexpensive. The driving device includes an electric motor including the yoke and a shaft. A control board of the driving device is connected to ground, and a seal connects the control board and the electric motor. The seal is conductive.

According to another feature, the control board includes at least one conductive track connected to ground and designed to make contact with the seal. According to another feature, the seal includes at least one clamp designed to make contact with one of the conductive tracks connected to ground. According to another feature, the seal is designed to hold the control board in translation. According to another feature, the driving device also includes a casing that is designed to house the shaft of the electric motor, and the seal is between the casing and the yoke. According to another feature, the casing includes two grooves approximately parallel to an axis of the shaft of the electric motor, and the grooves are designed to receive the control board.

The invention also provides a motor vehicle vent including a driving device for driving the motor vehicle vent according to the invention.

The invention also provides a method for obtaining an equipotential line between a yoke of a driving device and a control board of the driving device connected to ground. The method includes the steps of providing a casing, inserting the control board into the casing and positioning a conductive seal on the casing. The conductive seal is in contact with the control board. The method further includes the steps of positioning the yoke against the casing and fixing the yoke on the casing. The seal is in electrical contact with both the yoke and a conductive track of the control board connected to ground.

### BRIEF DESCRIPTION OF THE DRAWINGS

Other characteristics and advantages of the invention will become apparent when reading the following detailed description of the embodiments of the invention given as an example only and with reference to the drawings, which show:

FIG. 1 illustrates an exploded perspective view of a part of a driving device; and

FIG. 2 illustrates a perspective view of an electric motor.

### DETAILED DESCRIPTION OF THE DRAWINGS

The driving device according to the invention includes an electric motor having a yoke and a shaft. The driving device also includes a control board connected to ground. A conductive seal connects the control board and the electric motor. The electric motor is thus connected to ground via the conductive seal.

A seal is more reliable than pins because of its elastic properties. There is therefore less risk of the seal breaking. Moreover, even if one part of the seal is faulty or if the seal is broken at some point, the remainder of the seal can still fulfill its function as a conductor and correctly connect the yoke to ground. The use of a conductive seal thus makes it possible to produce a reliable connection. Moreover, the use of a conductive seal is less expensive than the use of a conductive braid. The driving device is, for example, a geared motor.

In the rest of the description, for ease of understanding, the driving device will be referred to as a geared motor. However, it should not be understood as limiting the invention to a geared motor.

FIG. 2 shows a perspective view of an electric motor 2 including a yoke 20 and a shaft 21. The yoke 20 contains a stator and a rotor, and the rotor is-connected to the shaft 21. The shaft 21 ends, for example, in a worm 17, as shown in FIG. 2. The geared motor also includes a reducing gear, for example. The shaft 21 rotatably drives the geared motor. Although they are not shown, the electric motor 2 also includes a commutator and brushes supplying the electric motor 2.

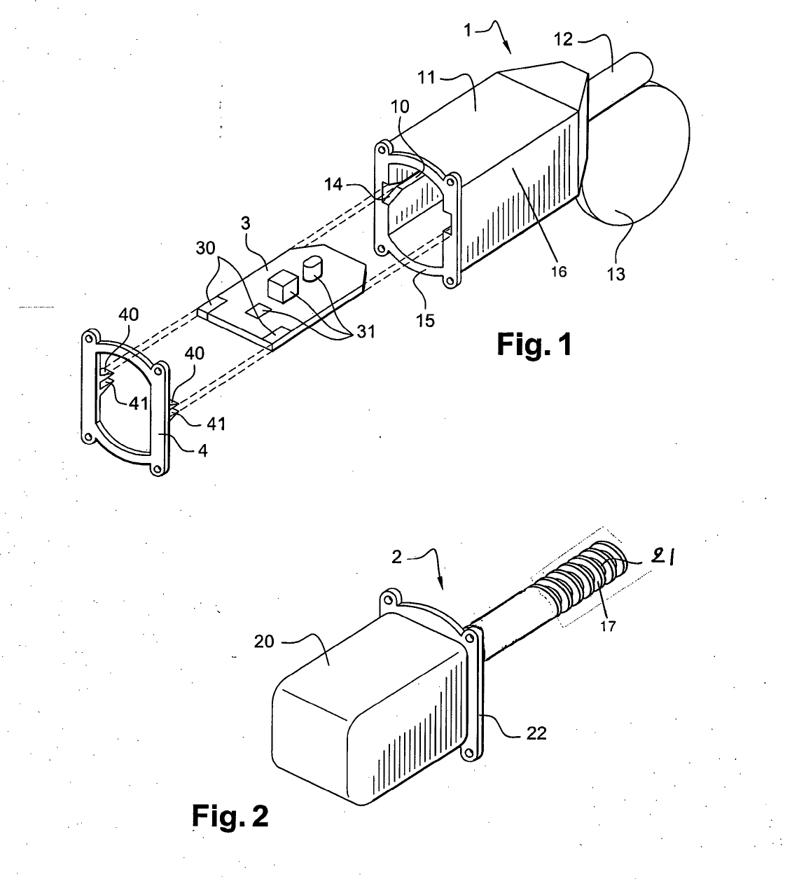

FIG. 1 shows an exploded perspective view of a part of the geared motor. The geared motor includes the electric motor 2 (FIG. 2) and a casing 1. The casing 1 is connected to the yoke 20. The yoke 20 is, for example, fixed to an edge 15 of an opening 16 of the casing 1. The opening 16 is designed for the insertion of the shaft 21 into the casing 1. The geared motor also includes a seal 4 which is inserted between the yoke 20 and the casing 1.

The casing 1 is designed to house the shaft 21 of the electric motor 2. The casing 1 is also designed to house a reducing gear. The casing 1 includes, for example, a first part 11 and 12 designed to house the shaft 21 and a second part 13 designed to house the reducing gear. The first part 11 and 12 can include a contracted part (shown as 12) designed to receive the worm 17 of the shaft 21.

The geared motor also includes a control board 3 for controlling the operation of the geared motor. For example, the control board 3 controls starting the electric motor 2, reversing its direction of rotation or stopping the electric motor 2. The control board 3 is of the printed circuit type and includes at least one electronic component 31 on its surface. The control board 3 also includes at least one conductive track 30 on its surface, preferably two conductive tracks 30, connected to ground via a connector.

The control board 3 is designed to be housed in the geared motor, in particular in the casing 1. The use of an additional housing for the control board 3 is thus avoided, which makes the geared motor more compact. The space occupied by the geared motor is thus reduced. Moreover, eliminating an external housing for the control board 3 reduces the manufacturing costs.

The seal 4 is a conductive seal and is situated between the casing 1 and the yoke 20. The seal 4 can be sandwiched between the casing 1 and the yoke 20, for example, by screwing down screws between the yoke 20 and the casing 1. The seal 4 thus makes it possible to seal the geared motor at the connection between the casing 1 and the yoke 20.

Because the seal 4 is conductive, the seal 4 also allows for electrical contact between the control board 3 and the yoke 20. The control board 3 is connected to ground. The electrical connection between the control board 3 and the yoke 20 therefore makes it possible to connect the yoke 20 to ground. Thus, an equipotential connection is obtained between the yoke 20 and the control board 3.

The seal 4 is made of flexible material. It is, for example, of the type sold under the trade marks CHO-SEAL® and CHO-SIL® (registered trade marks) by Chomerics, which includes an elastomer binder and a conductive filler. The conductive filler is, for example, a metal or graphite powder.

The casing 1 includes, for example, grooves 10 into which the control board 3 is inserted. The grooves 10 are approximately parallel to an axis of the shaft 21. The control board 3 therefore extends parallel (along the largest dimension of the board) to the shaft 21. This is advantageous for the assembly of the geared motor because the shaft 21 and the control board 3 can be inserted along the same axis into the casing 1. The grooves 10 in the casing 1 serve to hold the control board 3 in the casing 1.

The seal 4 is approximately planar. The seal 4 also includes at least one contact 40, preferably two contacts 40. The contacts 40 are, for example, in the form of a clamp. For this purpose, the contacts 40 are each provided with a channel 41 designed to receive the control board 3. Moreover, the contacts 40 are, for example, projecting relative to the general plane of the seal 4. The contacts 40 are an integral part of the seal 4.

Each channel 41 of the contact 40 receives a part of the control board 3 including the conductive track 30. A width of the channel 41 is approximately equal to the sum of a thicknesses of the control board 3 and the conductive track 30. Thus, when the control board 3 is inserted into the contacts 40 of the seal 4, the conductive tracks 30 are in electrical contact with the seal 4. The conductive tracks 30 are advantageously clamped in the channels 41 to ensure good electrical contact between the conductive tracks 30 of the control board 3 and the seal 4.

The control board 3 is connected to ground. Thus, when the control board 3 is inserted into the seal 4 and the seal 4 is in contact with the yoke 20, the yoke 20 is connected to ground via the seal 4, the conductive tracks 30 and the control board 3.

The grooves 10 in the casing 1 each include a flare 14 near to the opening 16 for the insertion of the shaft 21 into the casing 1. The flares 14 allow the contacts 40 of the seal 4 to be received when the seal 4 is inserted between the casing 1 and the yoke 20. The flares 14 allow for easy insertion of the control board 3 into the casing 1. The grooves 10 in the casing 1 can have a length approximately equal to a length of the control board 3. Thus, the seal 4 serves to hold the control board 3 in translation.

The casing 1 also includes an edge 15 around the opening 16 for the insertion of the shaft 21 into the casing 1. The yoke 20 also includes an edge 22 designed to come into contact with the edge 15 of the casing 1. The seal 4 is inserted between the edges 15 and 22 of the casing 1 and of the yoke 20. The dimensions and the shape of the edges 15 and 22 of the casing 1 and of the yoke 20, and those of the seal 4, are therefore similar to coincide approximately when the geared motor is assembled in order to ensure a good seal.

The assembly of the geared motor is carried out in the following manner. The control board 3 is inserted into the grooves 10 in the casing 1. The seal 4 is then placed on the edge 15 of the casing 1, and the contacts 40 of the seal 4 are inserted into the flares 14 of the casing 1. The conductive tracks 30 on the control board 3 are then inserted into the channels 41 of the contacts 40 of the seal 4. The shaft 21 is then inserted into the casing 1. Then the yoke 20 and the seal 4 are fixed, preferably simultaneously, onto the casing 1. The fixing of the yoke 20 onto the casing 1 is, for example, carried out by screwing down screws passing through the edges 15 and 22 of both the casing 1 and the yoke 20. During the screwing, the seal 4 is compressed in the longitudinal direction of the casing 1. Therefore, a good contact between the yoke 20 and the seal 4 is ensured. The contacts 40 of the seal 4 are also compressed in the longitudinal direction. Compression of the contacts 40 also occurs in a transverse direction due to the slope of the flares 14 of the casing 1. A good contact between the seal 4 and the conductive tracks 30 of the control board 3 is ensured. Once the geared motor has been assembled, an equipotential line is obtained between the yoke 20 and the control board 3.

The conductive seal 4 of the geared motor also makes it possible to reduce or to block electromagnetic radiation of the electric motor 2. A conventional seal made of rubber or elastomer arranged between the casing 1 of the geared motor and the electric motor 2 allows the electromagnetic radiation to pass from the electric motor 2 to the outside. This can lead to interference with the other equipment in the vehicle or even with equipment outside the vehicle. The geared motor according to the invention, provided with the seal 4, has the advantage of reducing or eliminating these drawbacks with the seal 4 acting as a shield.

The use of a seal 4 that is conductive also makes it possible to avoid noise being produced in the event of vibrations of the geared motor because the seal 4 is a shock absorber and replaces a rigid contact that can cause noises.

The driving device in particular allows for the driving of a motor vehicle vent, such as a window or a sunroof. For example, a geared motor can be arranged in a motor vehicle door to drive a window. Alternatively, the driving device can be arranged on the body of motor vehicle to drive a tailgate or a sliding door. In one variant, the driving device can be arranged directly on the tailgate or the sliding door. The driving device can also be arranged on the roof of a motor vehicle to drive a sun roof.

Of course, this invention is not limited to the embodiments described as examples. Thus, the control board 3 can be arranged in the casing 1 with its width along the axis of the shaft 21 and not with its length along the axis of the shaft 21 as described above.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A driving device comprising:
an electric motor including a yoke and a shaft;
a control board connected to ground; and
a seal connecting the control board and the electric motor, wherein the seal is conductive.

2. The driving device according to claim 1, wherein the seal electrically connects the control board to the yoke.

3. The driving device according to claim 1, wherein the control board includes at least one conductive track connected to ground and designed to make contact with the seal.

4. The driving device according to claim 3, wherein the seal includes at least one clamp designed to make contact with one of the at least one conductive track connected to ground.

5. The driving device according to claim 1, wherein the seal is designed to hold the control board in translation.

6. The driving device according to claim 1, further including a casing designed to house the shaft, wherein the seal is between the casing and the yoke.

7. The driving device according to claim 6, wherein the shaft has an axis and the casing includes two grooves approximately parallel to the axis, and the two grooves are designed to receive the control board.

8. A motor vehicle vent comprising:
a driving device for driving the motor vehicle vent, the driving device including:
an electric motor including a yoke and a shaft;
a control board connected to ground; and
a seal connecting the control board and the electric motor, wherein the seal is conductive.

9. The motor vehicle vent according to claim 8, wherein the seal electrically connects the control board to the yoke.

10. The motor vehicle vent according to claim 8, wherein the control board includes at least one conductive track connected to ground and designed to make contact with the seal.

11. The motor vehicle vent according to claim 10, wherein the seal includes at least one clamp designed to make contact with one of the at least one conductive track connected to ground.

12. The motor vehicle vent according to claim 8, wherein the seal is designed to hold the control board in translation.

13. The motor vehicle vent according to claim 8, wherein the driving device further includes a casing designed to house the shaft, and the seal is between the casing and the yoke.

14. The motor vehicle vent according to claim 13, wherein the shaft has an axis and the casing includes two grooves approximately parallel to the axis, and the two grooves are designed to receive the control board.

15. A method for obtaining an equipotential line between a yoke of an electric motor of a driving device and a control board of the driving device connected to ground, the method comprising the:
steps of:
inserting a control board into a casing of a driving device;
positioning a conductive seal on the casing, wherein the conductive seal is in contact with the control board;
positioning a yoke of an electric motor against the casing; and
fixing the yoke on the casing, wherein the conductive seal is in electrical contact with both the yoke and a conductive track on the control board connected to ground.

16. The method according to claim 15, wherein the conductive track is designed to make contact with the conductive seal.

17. The method according to claim 16, wherein the conductive seal includes at least one clamp designed to make contact with the conductive track connected to ground.

18. The method according to claim 15, wherein the conductive seal is designed to hold the control board in translation.

19. The method according to claim 15, wherein the casing is designed to house a shaft of the electric motor, and the conductive seal is between the casing and the yoke.

20. The method according to claim 19, wherein the casing includes two grooves approximately parallel to an axis of the shaft, and the control board is inserted into the two grooves.
